(19) United States
(12) Patent Application Publication
(10) Pub. No.: US 2026/0089794 A1
(43) Pub. Date: Mar. 26, 2026

(54) Multi-SIM Call Setup Optimizations for Inactive State

(71) Applicant: Apple Inc., Cupertino, CA (US)

(72) Inventors: Ashish Kumar SINGH, Munich (DE); Avinash VENUGOPAL, San Diego, CA (US); Xiaolin ZHAO, San Diego, CA (US)

(21) Appl. No.: 19/113,648

(22) PCT Filed: Sep. 12, 2023
(86) PCT No.: PCT/US2023/032512

§ 371 Date: Mar. 20, 2025

Related U.S. Application Data
(60) Provisional application No. 63/376,662, filed on Sep. 22, 2022.

(51) Int. Cl. H04W 76/27; H04W 76/18

(52) U.S. Cl. CPC H04W 76/27; H04W 76/18

(57) ABSTRACT

A user equipment (UE) configured to enter an RRC INACTIVE state on a first network using a first SIM and an RRC INACTIVE or RRC IDLE state on a second network using a second SIM, initiate an RRC resume including a resume request including a cause indication on the first SIM, during the RRC resume, decode a trigger for a service on the second SIM having a higher priority than the RRC resume, based on the trigger, initiate a multi-SIM suspend procedure on the first SIM, the multi-SIM suspend procedure including a multi-SIM suspend request from the NAS entity of the first SIM to the RRC entity of the first SIM and, at the RRC entity of the first SIM, delay an execution of the multi-SIM suspend request6 until a response to an RRC resume request is received from the first network.

### PRIORITY/INCORPORATION BY REFERENCE

This application claims priority to U.S. Provisional Application Ser. No. 63/376,662 filed on Sep. 22, 2022, and entitled “Multi-SIM Call Setup Optimizations For Inactive State,” the entirety of which is incorporated herein by reference.

### BACKGROUND

A user equipment (UE) may be equipped with multiple subscriber identification modules (SIMs) and each SIM may enable the UE to establish an independent network connection. Thus, a multi-SIM UE may establish a first network connection using a first SIM and a second network connection using a second SIM.

During multi-SIM operation, the UE may be in the radio resource control (RRC) INACTIVE state on a first SIM with a first network, e.g., the 5G New Radio (NR) radio access network (RAN), and may be in the IDLE or INACTIVE state on a second SIM with a second network. The UE may initiate or receive a trigger (e.g., paging message) for an RRC resume procedure on the first SIM, e.g., to enter the RRC CONNECTED state, to perform a RAN based notification area (RNA) procedure, or for other reasons. The RRC resume procedure requires multiple processing steps at the lower layers of the UE and a signaling exchange with the network that may span, e.g., hundreds of milliseconds. During the resume operation on the first SIM the second SIM may request a service, e.g., a high priority voice call may be triggered. The UE behavior in this scenario is not well-defined and may depend on UE implementation. In one example, the UE may end the resume operation on the first SIM prematurely and provide the Layer 1 (L1) resources to the second SIM. However, this behavior may lose the RRC INACTIVE context on the first SIM (e.g., cause the first SIM to enter the RRC IDLE state) and/or cause an RRC context mismatch between the UE and the first network.

### SUMMARY

Some exemplary embodiments are related to an apparatus of a user equipment (UE), the apparatus having processing circuitry configured to enter a radio resource control (RRC) INACTIVE state on a first network using a first subscriber identification module (SIM) and an RRC INACTIVE or RRC IDLE state on a second network using a second SIM, initiate an RRC resume procedure on the first SIM, the RRC resume procedure including a transmission of a resume request including a cause indication from a non-access stratum (NAS) entity of the first SIM to an RRC entity of the first SIM, during the RRC resume procedure on the first SIM, decode, based on signals received from a base station, a trigger for a service on the second SIM having a higher priority than the RRC resume procedure on the first SIM, based on the trigger for the service on the second SIM, initiate a multi-SIM suspend procedure on the first SIM, the multi-SIM suspend procedure including a transmission of a multi-SIM suspend request from the NAS entity of the first SIM to the RRC entity of the first SIM and at the RRC entity of the first SIM, delay an execution of the multi-SIM suspend request until a response to an RRC resume request is received from the first network.

Other exemplary embodiments are related to a user equipment (UE) having a transceiver configured to communicate with a first network and a second network and a processor communicatively coupled to the transceiver. The processor is configured to enter a radio resource control (RRC) INACTIVE state on the first network using a first subscriber identification module (SIM) and an RRC INACTIVE or RRC IDLE state on the second network using a second SIM, initiate an RRC resume procedure on the first SIM, the RRC resume procedure including a transmission of a resume request including a cause indication from a non-access stratum (NAS) entity of the first SIM to an RRC entity of the first SIM, during the RRC resume procedure on the first SIM, decode, based on signals received from a base station, a trigger for a service on the second SIM having a higher priority than the RRC resume procedure on the first SIM, based on the trigger for the service on the second SIM, initiate a multi-SIM suspend procedure on the first SIM, the multi-SIM suspend procedure including a transmission of a multi-SIM suspend request from the NAS entity of the first SIM to the RRC entity of the first SIM and at the RRC entity of the first SIM, delay an execution of the multi-SIM suspend request until a response to an RRC resume request is received from the first network.

### BRIEF DESCRIPTION OF THE DRAWINGS

FIG. 1 shows an exemplary network arrangement according to various exemplary embodiments.

FIG. 2 shows an exemplary multi-SIM UE according to various exemplary embodiments.

FIG. 3 shows an exemplary network base station according to various exemplary embodiments.

FIG. 4 shows a signaling diagram for multi-SIM (MSIM) high priority call handling when the high priority call is triggered on a second SIM (SIM B) of a multi-SIM UE while an RRC resume procedure is ongoing for a first SIM (SIM A) of the UE according to one example.

FIG. 5 shows a signaling diagram for multi-SIM (MSIM) high priority call handling when the high priority call is triggered on a second SIM (SIM B) of a multi-SIM UE while an RRC resume procedure is ongoing for a first SIM (SIM A) of the UE according to a first aspect of these exemplary embodiments.

FIG. 6 shows a signaling diagram for multi-SIM (MSIM) high priority call handling when the high priority call is triggered on a second SIM (SIM B) of a multi-SIM UE while an RRC resume procedure is ongoing for a first SIM (SIM A) of the UE according to a second aspect of these exemplary embodiments.

FIG. 7 shows a signaling diagram for multi-SIM (MSIM) high priority call handling when the high priority call is triggered on a second SIM (SIM B) of a multi-SIM UE while an RRC resume procedure is ongoing for a first SIM (SIM A) of the UE according to a third aspect of these exemplary embodiments.

FIG. 8 shows a signaling diagram for multi-SIM (MSIM) high priority call handling when the high priority call is triggered on a second SIM (SIM B) of a multi-SIM UE while an RRC resume procedure is ongoing for a first SIM (SIM A) of the UE according to a fourth aspect of these exemplary embodiments.

FIG. 9 shows a signaling diagram for multi-SIM (MSIM) high priority call handling when the high priority call is triggered on a second SIM (SIM B) of a multi-SIM UE while an RRC resume procedure is ongoing for a first SIM (SIM A) of the UE according to a fifth aspect of these exemplary embodiments.

### DETAILED DESCRIPTION

The exemplary embodiments may be further understood with reference to the following description and the related appended drawings, wherein like elements are provided with the same reference numerals. The exemplary embodiments describe operations for a user equipment (UE) to maintain a radio resource control (RRC) inactive state on a first subscriber identification module (SIM) and/or avoid an RRC state mismatch with the network when an RRC resume procedure on the first SIM is interrupted by a service request on a second SIM during multi-SIM operation.

In some aspects, the RRC entity for the first SIM can save, or delay the execution of, a suspend request from a multi-SIM manager of the UE until a response to a resume request on the first SIM is received from the network. After the response is received, the UE can first handle the response (and potentially maintain the INACTIVE context on the first SIM) and subsequently handle the multi-SIM suspend request to allow the high priority service on the second SIM. In other aspects, the RRC entity for the first SIM can end the RRC resume procedure prematurely while ensuring that the network and the UE have (or will have) matching RRC contexts. In one embodiment, the UE provides UE assistance information to the network indicating a preferred RRC state.

The exemplary embodiments provide mechanisms for the UE to maintain the INACTIVE context while minimizing signaling between the UE and the network and avoiding the need for a tracking area update (TAU) procedure. This may provide power savings in the UE, improved user experience, and more optimized network resource usage.

The exemplary embodiments are described with regard to a UE. However, reference to a UE is merely provided for illustrative purposes. The exemplary embodiments may be utilized with any electronic component that may establish a connection to a network and is configured with the hardware, software, and/or firmware to exchange information and data with the network. Therefore, the UE as described herein is used to represent any electronic component.

Throughout this description, the UE is characterized as a multi-SIM UE. The term “multi-SIM UE” may refer to a UE equipped with multiple (e.g., two or more) SIMs. Each SIM may be used to establish an independent network connection and each network connection may exist simultaneously. Thus, each SIM may be associated with its own telephone number and/or subscription with a cellular service provider. Accordingly, a single UE may be associated with two or more telephone numbers and/or subscriptions. Throughout this description, for the purpose of differentiating between SIMs, reference will be made to a first SIM (SIM A) connecting to a first network (NW) (NW A) and a second SIM (SIM B) connecting to a second NW (NW B). However, this is only intended to differentiate between the two SIMs and is not intended to indicate any sort of priority/preference between either SIM A or SIM B. In one example, SIM A refers to a SIM with simId=0 and SIM B refers to a SIM with simID=1 saved locally at the UE. In addition, the SIM A, SIM B, NW A and NW B are described only for illustrative purposes, and the principles described in the present disclosure may be applied to any number of SIM and network combinations.

A person of ordinary skill in the art would understand that a SIM contains information that is used by the UE to establish a network connection. For example, the SIM may include an international mobile subscriber identifier (IMSI) that may be used for authentication with the network provider. A user may have a first subscription with a cellular service provider that is enabled by SIM A and a second subscription with the cellular service provider that is enabled by SIM B. The network to which the UE may connect using SIM A may be referred to as network A (NW A) and the network to which the UE may connect using SIM B may be referred to as network B (NW B). In one example, the same cellular service provider is associated with both SIM A and SIM B. In another example, a different cellular service provider is associated with each SIM. Reference to any particular type of information being included in a SIM is merely provided for illustrative purposes. A SIM may include a wide variety of different types of information that different networks or entities may refer to by different names. Accordingly, the exemplary embodiments may apply to a SIM that contains any type of information used by the multi-SIM UE to establish a network connection.

Throughout this description reference is made to the SIMs performing a function (e.g., communicating with the wireless network). However, those skilled in the art will understand that the SIMS themselves do not perform any functions or operations. Rather, the UE, or more precisely a processor of the UE, implements one or more protocol stacks using the credentials and other information stored on the SIMS and then establishes a connection with networks using the one or more protocol stacks. Thus, when referring to a SIM communicating with a network, this should be understood to include the UE or the processor of the UE communicating via a connection associated with the SIM. Similarly, any other operation attributed to the SIM herein should be understood to be an operation being performed by a protocol stack implemented by the processor using the information provided by the SIM.

The exemplary embodiments will be described with respect to a multi-SIM UE equipped with two SIMs, e.g., SIM A and SIM B. However, those skilled in the art will understand that the exemplary embodiments may also apply to devices that have more than two SIMs.

The multi-SIM UE may utilize the same hardware, software and/or firmware components to perform operations related to the network connection associated with SIM A and the network connection associated with SIM B. For example, the multi-SIM UE may be configured to use the same transceiver to perform operations related to both network connections. Using the same component to perform operations for both network connections may create a scenario in which the multi-SIM UE is unable to perform an operation related to the network connection associated with one of SIM A or SIM B because the multi-SIM UE is currently using that component to perform an operation related to the network connection associated with the other SIM.

The multi-SIM UE may be in the RRC INACTIVE state on NW A with SIM A and the RRC INACTIVE or RRC IDLE state on NW B with SIM B. An RRC resume procedure may be initiated on SIM A for any of a number of reasons, e.g., to enter the RRC CONNECTED state, to perform a RAN based notification area (RNA) procedure, or for other reasons. During the RRC resume operation on the first SIM, the second SIM may request a high priority service, e.g., a high priority voice call may be triggered. The exemplary embodiments describe operations for providing the UE with an opportunity to reenter the RRC INACTIVE state on SIM A (and NW A) and/or avoid an RRC context mismatch with NW A if the RRC resume procedure is ended prematurely.

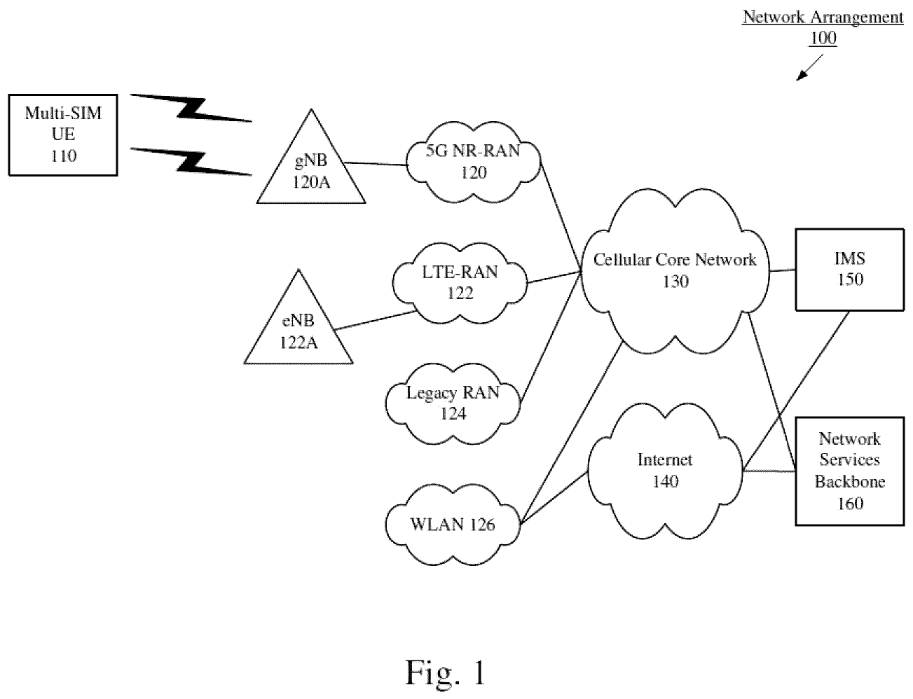

FIG. 1 shows a network arrangement 100 according to the exemplary embodiments. The network arrangement 100 includes a multi-SIM UE 110 that includes at least two SIMs. Those skilled in the art will understand that the multi-SIM UE 110 may be any type of electronic component that is configured to communicate via a network, e.g., mobile phones, tablet computers, smartphones, phablets, embedded devices, wearable devices, Cat-M devices, Cat-M1 devices, MTC devices, eMTC devices, other types of Internet of Things (IoT) devices, etc. An actual network arrangement may include any number of UEs being used by any number of users. Thus, the example of a single multi-SIM UE 110 is only provided for illustrative purposes.

The multi-SIM UE 110 may communicate with one or more networks. In the example of the network configuration 100, the networks with which the multi-SIM UE 110 may wirelessly communicate are a 5G New Radio (NR) radio access network (5G NR-RAN) 120, an LTE radio access network (LTE-RAN) 122, a legacy access network (legacy RAN) and wireless local access network (WLAN) 126. However, the multi-SIM UE 110 may also communicate with other types of networks and the multi-SIM UE 110 may also communicate with networks over a wired connection. Therefore, the multi-SIM UE 110 may include a 5G NR chipset to communicate with the 5G NR-RAN 120, an LTE chipset to communicate with the LTE-RAN 122, a legacy chipset to communicate with the legacy RAN 124 and an ISM chipset to communicate with the WLAN 126.

The multi-SIM UE 110 may establish multiple independent network connections that may exist simultaneously. For example, the multi-SIM UE 110 may establish a first network connection using SIM A and a second network connection with a network using SIM B. The first network connection and the second network connection may be independent from one another and exist simultaneously. In the example of the network configuration 100, the multi-SIM UE 110 is camped on the gNB 120A of the 5G NR-RAN 120 for the first network connection and on the eNB 122A of the LTE-RAN 122 for the second network connection. However, this is merely provided for illustrative purposes. For example, the multi-SIM UE 110 may establish first and second network connections to the 5G NR-RAN 120 via the gNB 120A. In another example, the multi-SIM UE 110 may establish a first network connection to the 5G NR-RAN 120 via the gNB 120A and a second network connection to the legacy RAN 124 via a corresponding base station 124A. Thus, in an actual network arrangement, the multi-SIM UE 110 may camp on a first cell corresponding to a first network for the first network connection and a second cell corresponding to a second network for the second network connection.

The 5G NR-RAN 120, the LTE-RAN 122 and the legacy RAN 124 may be portions of cellular networks that may be deployed by cellular providers (e.g., Verizon, AT&T, T-Mobile, etc.). These networks 120, 122, 124 may include, for example, base stations (Node Bs, eNodeBs, HeNBs, eNBS, gNBs, gNodeBs, macrocells, microcells, small cells, femtocells, etc.) that are configured to send and receive traffic from UEs that are equipped with the appropriate cellular chip set. The WLAN 126 may include any type of wireless local area network (WiFi, Hot Spot, IEEE 802.11x networks, etc.).

The base stations (e.g., the gNB 120A, the eNB 122A, the base station 124A) may include one or more communication interfaces to exchange data and/or information with camped UEs, the corresponding RAN, the cellular core network 130, the internet 140, etc. Further, the base stations may include a processor configured to perform various operations. For example, the processor of the base station may be configured to perform operations related to paging. However, reference to a processor is merely for illustrative purposes. The operations of the base station may also be represented as a separate incorporated component of the base station or may be a modular component coupled to the base station, e.g., an integrated circuit with or without firmware. For example, the integrated circuit may include input circuitry to receive signals and processing circuitry to process the signals and other information. In addition, in some base stations, the functionality of the processor is split among two or more processors such as a baseband processor and an applications processor. The exemplary embodiments may be implemented in any of these or other configurations of a base station.

Those skilled in the art will understand that any association procedure may be performed for the multi-SIM UE 110 to connect to the 5G NR-RAN 120, the LTE-RAN 122 and the legacy RAN 124. To provide an example, the 5G NR-RAN 120 may be associated with a particular cellular service provider where the multi-SIM UE 110 and/or the user thereof has a contract and credential information (e.g., stored on each of SIM A and SIM B). In the case of the multi-SIM UE 110, each SIM will independently connect to the corresponding network. Upon detecting the presence of the 5G NR-RAN 120, the multi-SIM UE 110 may transmit the corresponding credential information to associate with the 5G NR-RAN 120. More specifically, the multi-SIM UE 110 may associate with a specific cell (e.g., the gNB 120A of the 5G NR-RAN 120). Similar association procedures may be performed for the multi-SIM UE 110 to connect to the LTE-RAN 122 and the legacy RAN 124.

In addition to the networks 120, 122, 124 and 126 the network arrangement 100 also includes a cellular core network 130, the Internet 140, an IP Multimedia Subsystem (IMS) 150, and a network services backbone 160. The cellular core network 130 may be considered to be the interconnected set of components that manages the operation and traffic of the cellular network. The cellular core network 130 also manages the traffic that flows between the cellular network and the Internet 140. The IMS 150 may be generally described as an architecture for delivering multimedia services to the multi-SIM UE 110 using the IP protocol. The IMS 150 may communicate with the cellular core network 130 and the Internet 140 to provide the multimedia services to the multi-SIM UE 110. The network services backbone 160 is in communication either directly or indirectly with the Internet 140 and the cellular core network 130. The network services backbone 160 may be generally described as a set of components (e.g., servers, network storage arrangements, etc.) that implement a suite of services that may be used to extend the functionalities of the multi-SIM UE 110 in communication with the various networks.

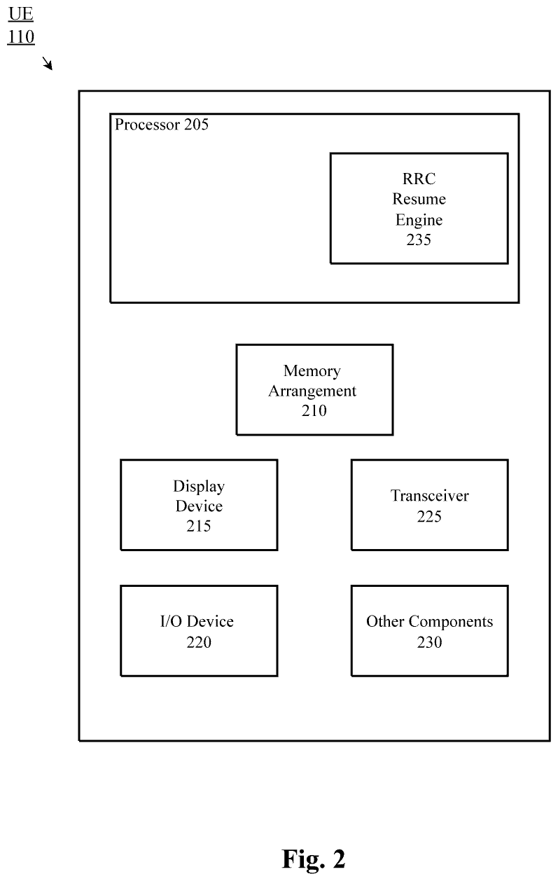

FIG. 2 shows an exemplary multi-SIM UE 110 according to various exemplary embodiments. The multi-SIM UE 110 will be described with regard to the network arrangement 100 of FIG. 1. The multi-SIM UE 110 may represent any electronic device and may include a processor 205, a memory arrangement 210, a display device 215, an input/output (I/O) device 220, a transceiver 225, and other components 230. The other components 230 may include, for example, an audio input device, an audio output device, a battery that provides a limited power supply, a data acquisition device, ports to electrically connect the multi-SIM UE 110 to other electronic devices, sensors to detect conditions of the UE 110, etc. The multi-SIM UE 110 may include SIM A 240 and a SIM B 245. However, as mentioned above, the exemplary embodiments may apply to a UE equipped with more than two SIMs.

The processor 205 may be configured to execute a plurality of engines for the multi-SIM UE 110. For example, the engines may include an RRC resume engine 235. The RRC resume engine 235 may perform operations for handling a scenario where an RRC resume procedure is ongoing on a first SIM (e.g., SIM A) and a high priority service is requested on a second SIM (e.g., SIM B). The operations performed by the RRC resume engine 235 may depend on the cause for the RRC resume procedure, e.g., whether the RRC resume is for an RNA procedure. The RRC resume engine 235 can save a multi-SIM suspend request until a response to a RRC resume request is received from the network, whereupon the UE will first process the response and subsequently execute the multi-SIM suspend request. The RRC resume engine 235 can also provide UE assistance information to the network to indicate a preferred RRC state. Examples of these operations will be described in greater detail below.

The above referenced engine being an application (e.g., a program) executed by the processor 205 is only exemplary. The functionality associated with the engine may also be represented as a separate incorporated component of the multi-SIM UE 110 or may be a modular component coupled to the multi-SIM UE 110, e.g., an integrated circuit with or without firmware. For example, the integrated circuit may include input circuitry to receive signals and processing circuitry to process the signals and other information. The engine may also be embodied as one application or separate applications. In addition, in some UEs, the functionality described for the processor 205 is split among two or more processors such as a baseband processor and an application processor. The exemplary embodiments may be implemented in any of these or other configurations of a UE.

The memory 210 may be a hardware component configured to store data related to operations performed by the multi-SIM UE 110. As will be described in further detail below, the memory 210 may store data associated with the conditions of the multi-SIM UE 110 when a determination of the operating mode is performed. The display device 215 may be a hardware component configured to show data to a user while the I/O device 220 may be a hardware component that enables the user to enter inputs. The display device 215 and the I/O device 220 may be separate components or integrated together such as a touchscreen.

The transceiver 225 may be a hardware component configured to establish a connection with the LTE-RAN 120, the LTE-RAN 122, the legacy RAN 124 and the WLAN 126, etc. Accordingly, the transceiver 225 may operate on a variety of different frequencies or channels (e.g., set of consecutive frequencies). The transceiver 225 includes circuitry configured to transmit and/or receive signals (e.g., control signals, data signals). Such signals may be encoded with information implementing any one of the methods described herein. The processor 205 may be operably coupled to the transceiver 225 and configured to receive from and/or transmit signals to the transceiver 225. The processor 205 may be configured to encode and/or decode signals (e.g., signaling from a base station of a network) for implementing any one of the methods described herein.

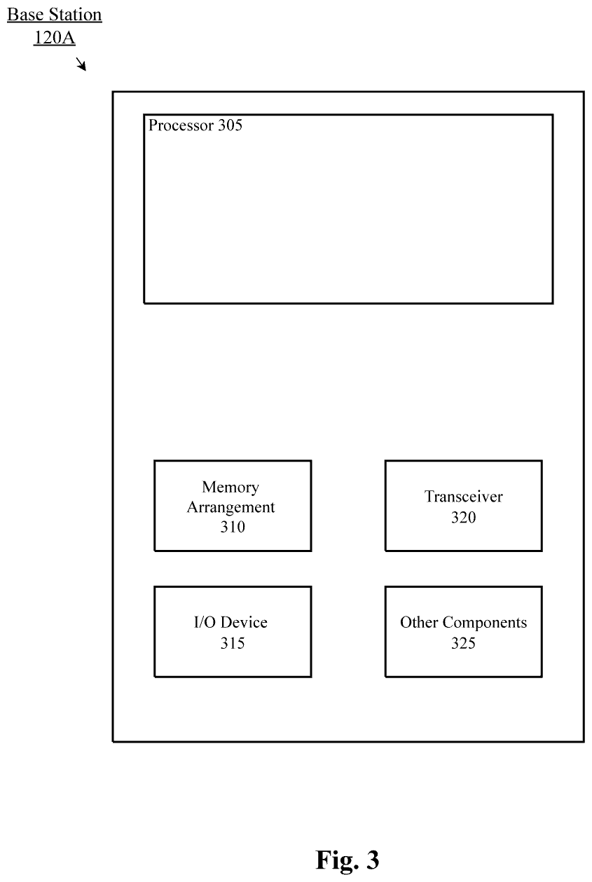

FIG. 3 shows an exemplary network cell, in this case gNB 120A, according to various exemplary aspects. As noted above with regard to the UE 110, the gNB 120A may represent a serving cell for the UE 110. The gNB 120A may represent any access node of the 5G NR network through which the UE 110 may establish a connection and manage network operations.

The gNB 120A may include a processor 305, a memory arrangement 310, an input/output (I/O) device 320, a transceiver 325, and other components 330. The other components 330 may include, for example, an audio input device, an audio output device, a battery, a data acquisition device, ports to electrically connect the gNB 120A to other electronic devices, etc.

The processor 305 may be configured to execute a variety of operations of the gNB 120A. For example, the processor may perform an RRC resume procedure with a UE in the RRC INACTIVE state. The above noted operations being an application (e.g., a program) executed by the processor 305 is only exemplary. The functionality may also be represented as a separate incorporated component of the gNB 120A or may be a modular component coupled to the gNB 120A, e.g., an integrated circuit with or without firmware. For example, the integrated circuit may include input circuitry to receive signals and processing circuitry to process the signals and other information. In addition, in some gNBs, the functionality described for the processor 305 is split among a plurality of processors (e.g., a baseband processor, an applications processor, etc.). The exemplary aspects may be implemented in any of these or other configurations of a gNB.

The memory 310 may be a hardware component configured to store data related to operations performed by the UEs 110. The I/O device 320 may be a hardware component or ports that enable a user to interact with the gNB 120A.

The transceiver 325 may be a hardware component configured to exchange data with the UE 110 and any other UE in the system 100. The transceiver 325 may operate on a variety of different frequencies or channels (e.g., set of consecutive frequencies). Therefore, the transceiver 325 may include one or more components (e.g., radios) to enable the data exchange with the various networks and UEs. The transceiver 320 includes circuitry configured to transmit and/or receive signals (e.g., control signals, data signals). Such signals may be encoded with information implementing any one of the methods described herein. The processor 305 may be operably coupled to the transceiver 320 and configured to receive from and/or transmit signals to the transceiver 320. The processor 305 may be configured to encode and/or decode signals (e.g., signaling from a UE) for implementing any one of the methods described herein.

The radio resource control (RRC) protocol comprises a state machine defining an operating state for a UE, each state having different radio resources associated therewith. In 5G NR and in LTE, the RRC states include the RRC CONNECTED state, the RRC INACTIVE state, and the RRC IDLE state. The UE enters into the RRC IDLE state upon powering up, and may perform operations including receiving broadcast messages, receiving paging messages, PLMN selection, and cell re-selection mobility. While in the RRC IDLE state, the UE follows a discontinuous reception (DRX) cycle for periodically waking up to listen for paging messages from the network. The UE is not registered to a cell and does not have an access stratum (AS) context. The UE may perform an initial access operation, including a random access (RACH) procedure, to camp on a network cell and enter the RRC CONNECTED state to establish a network connection and exchange transmissions with the network. If, while in the RRC CONNECTED state, there is no traffic to the UE or from the UE for some predefined period of time, the network may suspend the RRC connection and instruct the UE to enter the RRC INACTIVE state. In the RRC INACTIVE state, the UE may perform similar operations as in the RRC IDLE state. Additionally, the access stratum (AS) context may be saved at the UE and the network, allowing the UE to quickly re-enter the RRC CONNECTED state using a resume procedure when network activity for the UE is received at the UE/network. A UE in the RRC INACTIVE state can resume the suspended RRC connection in scenarios when, e.g., the UE is to enter the RRC CONNECTED state, the UE is to perform an RNA update, or upon reception of a paging message from the 5G RAN.

The RAN-based notification area (RNA) relates to an area within which the UE in the RRC INACTIVE state can move without notifying the RAN. The last serving gNB saves the UE context and, if downlink data/signaling for the UE is received from the AMF or UPF, the gNB can direct cells in the RNA to page the UE. When the UE is configured for the INACTIVE state, the gNB can configure the UE with a timer value (e.g., t380 timer) for triggering a periodic RNA update after the expiry of the timer. The RNA update can also be initiated by the UE when the UE moves out of the configured RNA. The RNA update is performed via an RRC resume procedure where the resume cause in the UE resume request is set to rna-Update. The gNB can further configure the UE with a second timer value (e.g., t319 timer) for receiving a response after the UE transmits an RRC resume request, wherein the expiry of the timer causes the UE to enter the RRC IDLE state and indicate a cause value for RRC resume failure.

The RRC resume procedure comprises a contention-based random access (RACH) procedure wherein the RRC resume request is transmitted in MSG3. The UE resume request (RRCResumeRequest or RRCResumeRequest1) can indicate one of: emergency, highPriorityAccess, mt-Access, mo-Signalling, mo-Data, mo-VoiceCall, mo-VideoCall, mo-SMS, rna-Update, mps-PriorityAccess, or mcs-PriorityAccess. The gNB receiving the resume request can move the UE to the RRC CONNECTED state (RRCResume or RRCSetup), the RRC IDLE state (RRCRelease) or the RRC INACTIVE state (RRCRelease with a suspend configuration, or RRCReject).

When the RNA update is requested, in many cases, the network will respond with an RRCRelease with a suspend configuration including an RNA configuration which may be a new configuration or may be the same configuration previously used. The UE re-enters the RRC INACTIVE state with a new t380 timer value and can use this RNA configuration until another RNA update is initiated/triggered.

Multi-SIM operations are defined in 3GPP TS 38.331 and 38.304. The multi-SIM UE may be in the RRC INACTIVE state on NW A with SIM A and the RRC INACTIVE or RRC IDLE state on NW B with SIM B. An RRC resume procedure may be initiated on SIM A to perform an RNA update or for another reason and, during the RRC resume operation on SIM A, SIM B may request a high priority service, e.g., a high priority voice call may be triggered. Currently, these 3GPP specifications do not specify the handling of this scenario. In particular, it is not specified what should be done with the access stratum (AS) INACTIVE context for SIM A. Currently, it is left up to the UE vendors for proprietary UE implementations. In one example, the UE can prematurely end (e.g., kill) the ongoing resume procedure, discard the RRC INACTIVE context and enter the RRC IDLE state on SIM A to provide the UE Layer 1 (L1) resources to SIM B for the high priority call.

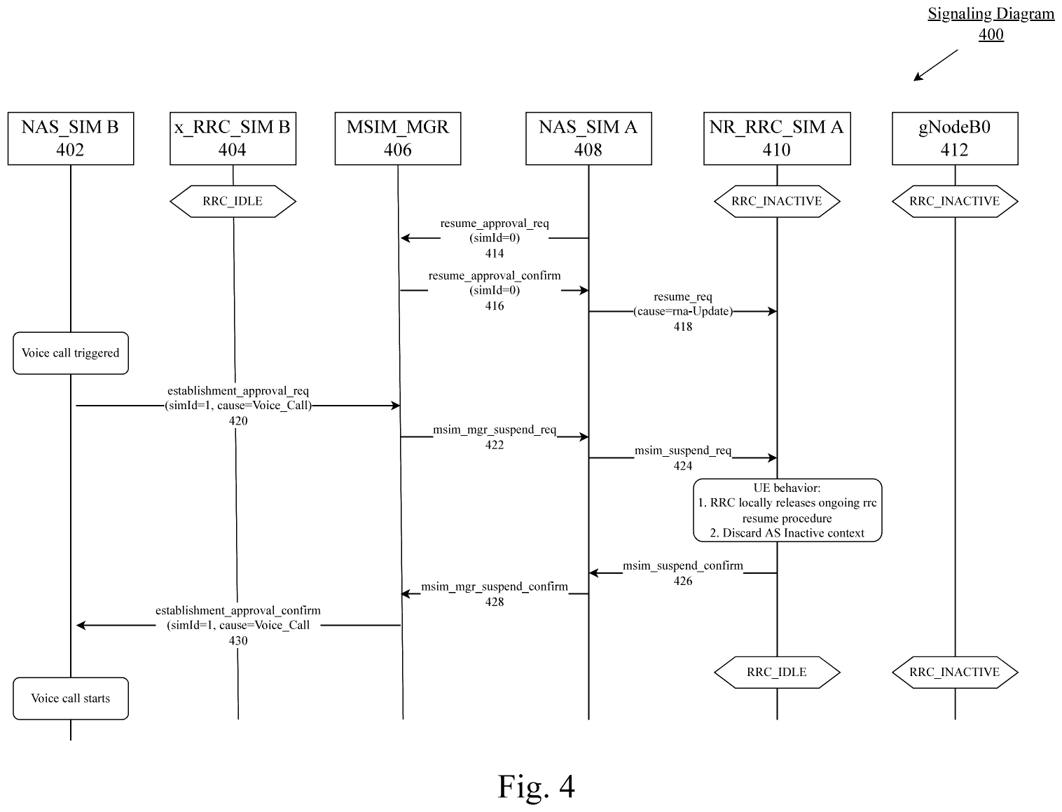

FIG. 4 shows a signaling diagram 400 for multi-SIM (MSIM) high priority call handling when the high priority call is triggered on a second SIM (SIM B) of a multi-SIM UE while an RRC resume procedure is ongoing for a first SIM (SIM A) of the UE according to one example. The signaling diagram 400 includes a first non-access stratum (NAS) entity 408 for a first SIM (NAS SIM A), an NR RRC entity 410 for the first SIM (NR_RRC_SIM A), a second NAS entity 402 for the second SIM (NAS SIM B), and an RRC entity 404 for the second SIM (x RRC SIM B). For example, the UE may have a first subscription with a first network (NW A) enabled by the first SIM (SIM A) and a second subscription with a second network (NW B) enabled by the second SIM (SIM B). The first SIM can be associated with a first ID (simID=0) and the second SIM can be associated with a second ID (simID=1). In this example, the NW A is the 5G NR RAN and the NW B can represent any appropriate RAT for performing voice calls, e.g., NR, LTE, etc. (represented by the “x” of the second RRC entity 404 for SIM B). The signaling diagram 400 further includes a multi-SIM manager 406 (MSIM_MGR) for administering the multi-SIM functionality of the UE. The first RRC entity 410 for SIM A can communicate with a gNB 412 of the 5G NR RAN. The gNB can be a serving gNB associated with a current RNA or associated with a different RNA.

In this example scenario, the SIM A is in the RRC INACTIVE state and the RRC INACTIVE context for the access stratum (AS) is maintained at the UE (NR_RRC_SIM A 410) and at the network (e.g., at gNB 412 or another gNB (e.g., a last serving gNB in the RNA)). The SIM B is in the RRC IDLE state and the RRC IDLE context is maintained at the UE (x_RRC_SIM B 404) and with the corresponding network of SIM B, which can be the same network as SIM A (e.g., the 5G NR RAN) or a different network. The RRC resume procedure can be initiated on SIM A for a number of reasons. In this example, the RRC resume procedure is initiated for an RNA update that may be triggered based on, e.g., the expiry of the T380 timer, the UE moving to a different RNA, or a page received from the gNB 412.

In 414, the first NAS entity 408 for SIM A transmits an RRC resume approval request to the MSIM manager 406 indicating the SIM ID of SIM A (e.g., simID=0). In 416, the MSIM manager 406 transmits an RRC resume approval confirm to the first NAS entity 408 including the SIM ID of SIM A. In 418, the NAS entity 408 for SIM A transmits a resume request to the RRC entity 410 for SIM A. In this example, the cause for the resume request indicates the RNA update.

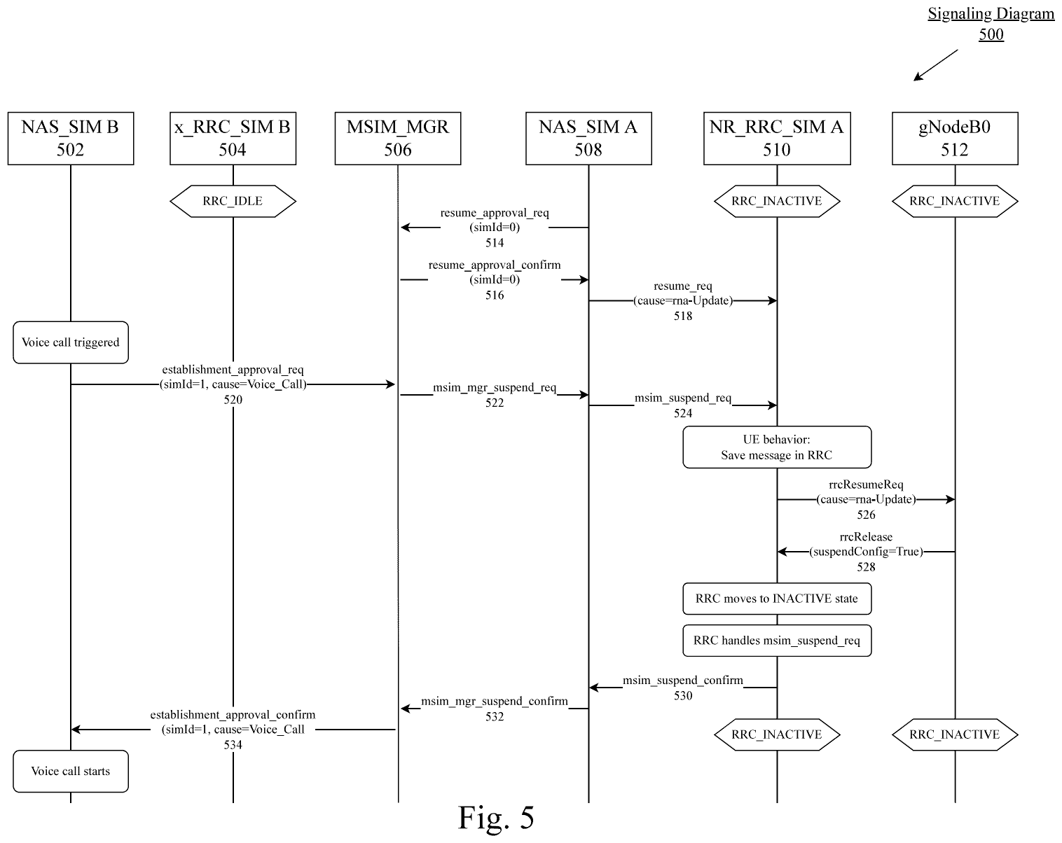

Upon receipt of the RRC resume request at the RRC entity 410 for SIM A, various operations subsequently occur in the lower layers of the SIM A protocol stack and in the network. For example, the RACH procedure is initiated so that the RRC resume request can be sent to the gNB 412. The RRC resume procedure is not completed until a response is received from the network (e.g., RRCReject, RRCResume, RRCSetup, or RRCRelease) and the UE implements the appropriate configuration. The execution of these operations can typically span a duration of some hundreds of milliseconds. As described above, when the RNA update is requested, the network can respond with an RRCReject or an RRCRelease. These signaling exchanges between the UE and the network for various types of RRC resume procedures will be described in further detail below with respect to the exemplary embodiments of FIGS. 5-9.

While the MSIM manager 406 is waiting for a resume confirmation from the NAS entity 408 of SIM A, a high priority voice call may be triggered on the second SIM (SIM B) of the UE.

In 420, the second NAS entity 402 for SIM B transmits an RRC establishment approval request to the MSIM manager 406 including the SIM ID of SIM B (simId=1) and a cause value indicating the voice call. The MSIM manager 406 can determine that the voice call on SIM B has a higher priority than the RNA update on SIM A and determine to provide the Layer 1 resources to SIM B.

In 422, the MSIM manager 406 transmits a RRC suspend request to the first NAS entity 408 for SIM A. In this example, the first NAS entity 408 has not yet received a resume confirmation from the first RRC entity 410 for the RNA update. In 424, the first NAS entity 408 transmits a multi-SIM suspend request to the first RRC entity 410 for SIM A.

Upon reception of the multi-SIM suspend request, the first RRC entity 410 locally releases the ongoing RRC resume procedure. Thus, the RRC resume operation is ended prematurely at whatever stage of the process is currently ongoing. For example, the UE may have not yet transmitted the RRC resume request to the gNB, or the UE may be waiting for a response to an RRC resume request that was already transmitted. When the RRC resume operation is ended prematurely, the SIM A inactive context is locally deleted by the UE and the SIM A enters the RRC IDLE state. The network (e.g., gNB 412), may be unaware that the UE has entered the RRC IDLE state.

In 426, the first RRC entity 410 for SIM A transmits a multi-SIM suspend confirm to the first NAS entity 408. In 428, the first NAS entity 408 transmits a suspend confirm to the MSM manager 406. In 430, the MSIM manager 406 transmits an establishment approval confirmation to the second NAS entity 402 for SIM B indicating the SIM ID of SIM B (e.g., simID=1) and a cause value indicating the voice call. The voice call can then begin on SIM B.

The procedure described above in FIG. 4 has various disadvantages. In some scenarios, the rrcResume procedure is not getting completed for SIM A and the inactive context for the SIM A RRC entity is deleted. In use cases such as reception of rrcReject or rrcRelease (suspendConfig=true) in response to rrcResumeRequest/1 (cause=rna-Update), the UE loses a good opportunity for maintaining the RRC INACTIVE context and hence loses all the benefits of the end-to-end system specified by 3GPP for the RRC INACTIVE state.

Additionally, after the call on SIM B is finished, SIM A has to perform the RACH procedure and initiate the RNA update again with the network. This requires a number of over the air (OTA) message exchanges to occur between the UE and network, which is inefficient for the network and the UE with respect to air interface resources. Further, during this reestablishment procedure on SIM A, SIM B is temporarily suspended again from using its Tx and Rx capabilities.

Further still, in some scenarios there will be context mismatch problems for the UE and the NW. Upon interruption by SIM B, before success of random access for rrcResumeRequest/1, SIM A has already deleted the whole INACTIVE context. The UE will be in RRC IDLE while the gNB will be in RRC INACTIVE.

The exemplary embodiments describe operations for providing the UE with an opportunity to reenter the RRC INACTIVE state on a first SIM (SIM A) and/or avoid an RRC context mismatch with the network of SIM A (NW A) if the RRC resume procedure on SIM A is ended prematurely. For example, as described above, the RRC resume procedure on SIM A may be interrupted by a high priority call triggering on a second SIM (SIM B). In some embodiments, the UE can allow the RRC resume procedure on SIM A to continue prior to suspending the RRC connection and switching to SIM B. In other embodiments, the UE prematurely ends the RRC resume procedure on SIM A only after receiving an RRC resume response from the network/gNB and, based on the response (e.g., if RRCResume is received), can provide UE assistance information to the network to indicate a preferred RRC state (e.g., RRC IDLE).

In some aspects of these exemplary embodiments, regarding an NR RRC entity for a first SIM currently performing an (ongoing) RRC resume procedure on the first SIM, the NR RRC entity can receive and save a multi-SIM suspend request received from the multi-SIM manager. The NR RRC entity can delay the execution/handling of the multi-SIM suspend request until an RRC release message is received from the network/gNB.

In some aspects, the RRC resume procedure is for an RNA update. During the RNA update procedure, the NR RRC entity transmits an RRC resume request to the network (including the cause value indicating the RNA update) and can receive in response an RRC release (including or not including a suspend configuration) or an RRC reject. In these aspects where the cause value is the RNA update, even when the NR RRC entity receives the multi-SIM suspend request prior to transmitting the RRC resume request to the network, the NR RRC entity will transmit the resume request and receive the response from the network prior to executing the multi-SIM suspend request. In some scenarios, the UE can re-enter the RRC INACTIVE state prior to executing the multi-SIM suspend request.

In other aspects, the RRC resume procedure can be for causes different from the RNA update. In these aspects, the UE can receive an RRC resume, an RRC setup, an RRC release, or an RRC reject in response to the RRC resume request. In various examples to be described below, the UE can either re-enter the RRC INACTIVE state or enter the RRC IDLE state. In some embodiments, the UE can provide UE assistance information to the network indicating a preferred RRC state, which may be the RRC IDLE state, when it is not possible to maintain the RRC INACTIVE state.

In some scenarios, the RRC resume procedure is for the RNA update. The following procedure may be used regardless of whether the UE has transmitted the RRC resume request (indicating the RNA update) to the network prior to reception of the multi-SIM suspend request.

FIG. 5 shows a signaling diagram 500 for multi-SIM (MSIM) high priority call handling when the high priority call is triggered on a second SIM (SIM B) of a multi-SIM UE while an RRC resume procedure is ongoing for a first SIM (SIM A) of the UE according to a first aspect of these exemplary embodiments. Similar to the signaling diagram 400 of FIG. 4, the signaling diagram 500 includes a second non-access stratum (NAS) entity 502 for a second SIM (NAS_SIM B), an RRC entity 504 for the second SIM (x_RRC_SIM B), a multi-SIM manager 506 (MSIM_MGR), a first NAS entity 508 for a first SIM (NAS_SIM A), an NR RRC entity 510 for the second SIM (NR_RRC_SIM A) and a gNB 512. Similar to above, the UE may have a first subscription with a first network (NW A) enabled by the first SIM (SIM A) and a second subscription with a second network (NW B) enabled by the second SIM (SIM B), wherein the first SIM can be associated with a first ID (simID=0) and the second SIM can be associated with a second ID (simID=1). The first SIM (SIM A) is in the RRC INACTIVE state and the RRC INACTIVE context is maintained at the UE (NR_RRC_SIM A 510) and at the network (gNB 512) and the second SIM (SIM B) is in the RRC IDLE state and the RRC IDLE context is maintained at the UE (x_RRC_SIM B 404) and with the corresponding network of SIM B, which can be the same network as SIM A (e.g., the 5G NR RAN) or a different network.

The steps 514-518 of the signaling diagram 500 of FIG. 5 may be performed similarly to the steps 414-418 of the signaling diagram 400 of FIG. 4. The first NAS entity 508 for the first SIM (NAS_SIM A) transmits an RRC resume approval request to the MSIM manager 506 indicating the SIM ID of SIM A (e.g., simID=0) (step 514); the MSIM manager 506 transmits an RRC resume approval confirm to the first NAS entity 508 including the SIM ID of SIM A (step 516); and the NAS entity 508 for SIM A transmits a resume request to the RRC entity 510 for SIM A indicating the RNA update cause value (step 518).

The steps 520-524 of the signaling diagram 500 of FIG. 5 may be performed similarly to the steps 420-424 of the signaling diagram 400 of FIG. 4. The service on the second SIM (SIM B) is triggered (e.g., high priority voice call) and the second NAS entity 502 for SIM B transmits an RRC establishment approval request to the MSIM manager 506 including the SIM ID of SIM B (simId=1) and a cause value indicating the voice call (step 520); the MSIM manager 506 determines that the voice call on SIM B has a higher priority than the RNA update on SIM A and transmits a RRC suspend request to the first NAS entity 508 for SIM A (step 522); and the first NAS entity 508 transmits a multi-SIM suspend request to the first RRC entity 510 for SIM A (step 524).

As mentioned above, the NR RRC entity 510 for SIM A has not yet received a response from the network (gNB 512) to a RRC resume request. In this example, the NR RRC entity 510 has not yet transmitted the RRC resume request (step 526 below). However, the UE behavior described below is performed regardless of whether the RRC resume request has already been transmitted.

According to the exemplary embodiments described herein, when the multi-SIM suspend request is received by the NR RRC entity 510, the NR RRC entity 510 temporarily saves the message and delays the execution of the multi-SIM suspend request. For example, the NR RRC entity 510 can save the message in RRC. The execution of the multi-SIM suspend request of step 524 is delayed until the NR RRC entity 510 receives a RRC release or an RRC reject from the network.

In 526, the NR RRC entity 510 transmits the RRC resume request to the gNB 512 indicating a cause value for the RNA update. In this example, in 528, the gNB 512 responds with an RRC release including a suspend configuration (e.g., suspendConfig=true and the associated suspend parameters).

The NR RRC entity 510 processes the response and, based on the response from the gNB 512 (including the suspend configuration), the NR RRC entity 510 re-enters the RRC INACTIVE state. Thus, the benefits of the RRC INACTIVE state are maintained and the UE avoids entering the RRC IDLE state.

With the RRC INACTIVE state intact, the NR RRC entity 510 retrieves the saved multi-SIM suspend request message and executes the message. Steps 530-534 of the signaling diagram 500 of FIG. 5 may be performed similarly to the steps 426-430 of the signaling diagram 400 of FIG. 4. The NR RRC entity 510 for SIM A transmits a multi-SIM suspend confirm to the first NAS entity 508 (step 530) ; the first NAS entity 508 transmits a suspend confirm to the MSIM manager 506 (step 532); and the MSIM manager 506 transmits an establishment approval confirmation to the second NAS entity 502 for SIM B indicating the SIM ID of SIM B (e.g., simID=1) and a cause value indicating the voice call (step 534). The voice call can then begin on SIM B.

The process described in FIG. 5 gives priority to the completion of the RNA update prior to providing the LI resources of the UE to SIM B for the high priority service. Although the high priority service of SIM B is slightly delayed, the delay is relatively small. For example, the UE handling of the RRC release message typically has a latency of approximately 150-300 ms. The benefits of the RRC INACTIVE state on SIM A remain intact, and there is no RRC state mismatch between the UE and the 5G NR RAN.

When the RNA update is requested by the UE, the most likely response from the network is the RRC release with suspend configuration, as described above in FIG. 5. However, it is also possible that the network responds with an RRC release without a suspend configuration, or an RRC reject.

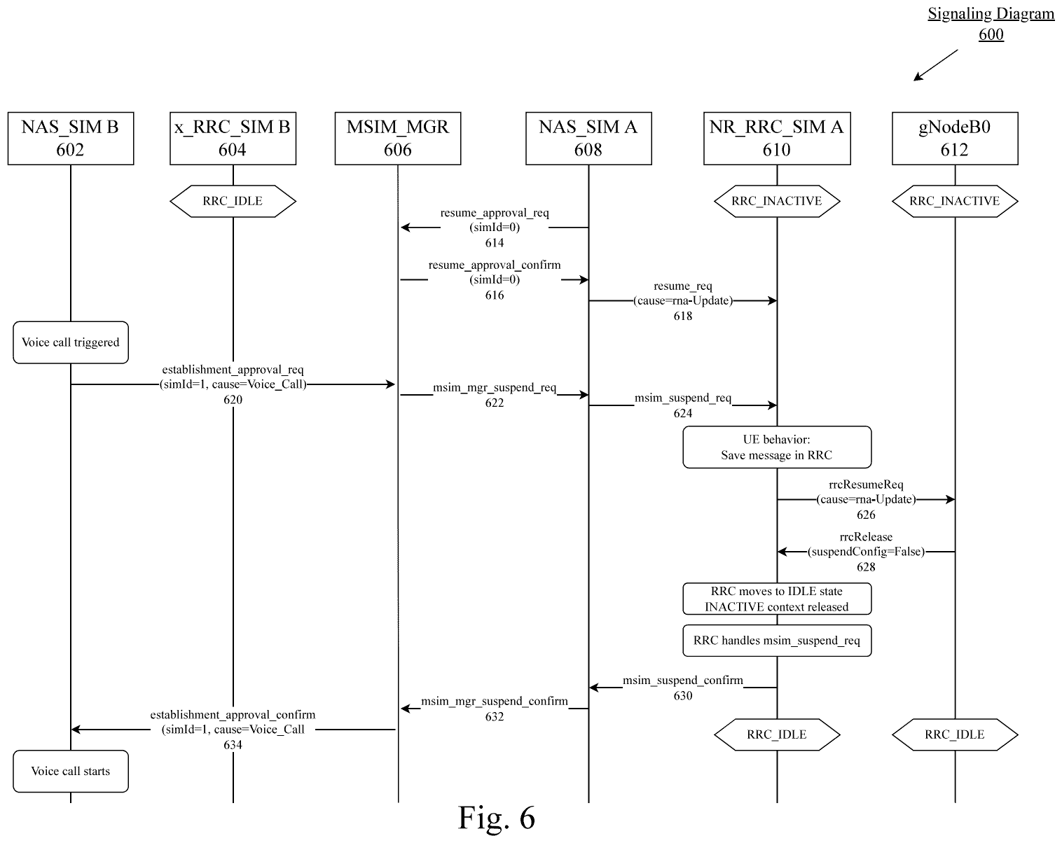

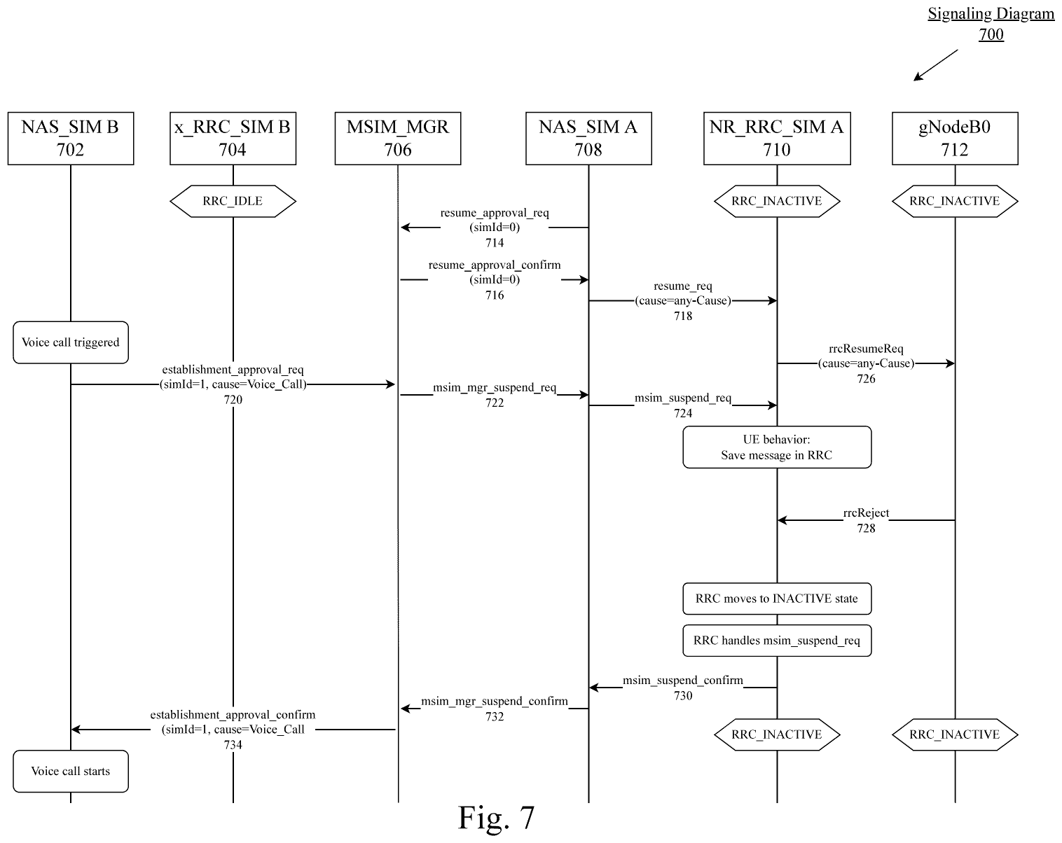

The RRC reject case will be described in further detail below with respect to FIG. 7, and is applicable for any RRC resume cause (including the RNA update or a different cause). The RRC release without suspend configuration case is described below in FIG. 6 with respect to the request for the RNA update. Similar to the signaling diagram 500 of FIG. 5, the following procedure may be used regardless of whether the UE has transmitted the RRC resume request (indicating the RNA update) to the network prior to reception of the multi-SIM suspend request.

In some scenarios, the RRC resume procedure is for the RNA update. The following procedure may be used regardless of whether the UE has transmitted the RRC resume request to the network prior to reception of the multi-SIM suspend request.

FIG. 6 shows a signaling diagram 600 for multi-SIM (MSIM) high priority call handling when the high priority call is triggered on a second SIM (SIM B) of a multi-SIM UE while an RRC resume procedure is ongoing for a first SIM (SIM A) of the UE according to a second aspect of these exemplary embodiments. Similar to the signaling diagram 500 of FIG. 5, the signaling diagram 600 includes a second non-access stratum (NAS) entity 602 for a second SIM (NAS_SIM B), an RRC entity 604 for the second SIM (x_RRC_SIM B), a multi-SIM manager 606 (MSIM_MGR), a first NAS entity 608 for a first SIM (NAS_SIM A), an NR RRC entity 610 for the second SIM (NR_RRC_SIM A) and a gNB 612. Similar to above, the UE may have a first subscription with a first network (NW A) enabled by the first SIM (SIM A) and a second subscription with a second network (NW B) enabled by the second SIM (SIM B), wherein the first SIM can be associated with a first ID (simID=0) and the second SIM can be associated with a second ID (simID=1). The first SIM (SIM A) is in the RRC INACTIVE state and the RRC INACTIVE context is maintained at the UE (NR_RRC_SIM A 610) and at the network (gNB 612) and the second SIM (SIM B) is in the RRC IDLE state and the RRC IDLE context is maintained at the UE (x_RRC_SIM B 604) and with the corresponding network of SIM B, which can be the same network as SIM A (e.g., the 5G NR RAN) or a different network.

The steps 614-618 of the signaling diagram 600 of FIG. 6 may be performed similarly to the steps 514-518 of the signaling diagram 500 of FIG. 5. The first NAS entity 608 for the first SIM (NAS_SIM A) transmits an RRC resume approval request to the MSIM manager 606 indicating the SIM ID of SIM A (e.g., simID=0) (step 614); the MSIM manager 606 transmits an RRC resume approval confirm to the first NAS entity 608 including the SIM ID of SIM A (step 616); and the NAS entity 608 for SIM A transmits a resume request to the RRC entity 610 for SIM A indicating the RNA update cause value (step 618).

The steps 620-624 of the signaling diagram 600 of FIG. 6 may be performed similarly to the steps 520-524 of the signaling diagram 500 of FIG. 5. The service on the second SIM (SIM B) is triggered (e.g., high priority voice call) and the second NAS entity 602 for SIM B transmits an RRC establishment approval request to the MSIM manager 606 including the SIM ID of SIM B (simId=1) and a cause value indicating the voice call (step 620); the MSIM manager 606 determines that the voice call on SIM B has a higher priority than the RNA update on SIM A and transmits a RRC suspend request to the first NAS entity 608 for SIM A (step 622); and the first NAS entity 608 transmits a multi-SIM suspend request to the first RRC entity 610 for SIM A (step 624).

As mentioned above, the NR RRC entity 610 for SIM A has not yet received a response from the network (gNB 612) to a RRC resume request. In this example, the NR RRC entity 610 has not yet transmitted the RRC resume request (step 626 below). However, the UE behavior described below is performed regardless of whether the RRC resume request has already been transmitted.

Similar to the signaling diagram 500 of FIG. 5, when the multi-SIM suspend request is received by the NR RRC entity 610, the NR RRC entity 610 temporarily saves the message and delays the execution of the multi-SIM suspend request. For example, the NR RRC entity 610 can save the message in RRC. The execution of the multi-SIM suspend request of step 624 is delayed until the NR RRC entity 610 receives a RRC release or an RRC reject from the network.

In 626, the NR RRC entity 610 transmits the RRC resume request to the gNB 612 indicating a cause value for the RNA update. In this example, in 628, the gNB 612 responds with an RRC release not including a suspend configuration (e.g., suspendConfig=false).

The NR RRC entity 610 processes the response and, based on the response from the gNB 612 (not including the suspend configuration), the NR RRC entity 610 enters the RRC IDLE state. The network (gNB 612) also enters the RRC IDLE state. Thus, it is ensured that the UE and the network are in sync with respect to the RRC context.

Similar to the signaling diagram 500 of FIG. 5, the NR RRC entity 610 retrieves the saved multi-SIM suspend request message and executes the message. Steps 630-634 of the signaling diagram 600 of FIG. 6 may be performed similarly to the steps 526-530 of the signaling diagram 500 of FIG. 5. The NR RRC entity 610 for SIM A transmits a multi-SIM suspend confirm to the first NAS entity 608 (step 630); the first NAS entity 608 transmits a suspend confirm to the MSIM manager 606 (step 632); and the MSIM manager 606 transmits an establishment approval confirmation to the second NAS entity 602 for SIM B indicating the SIM ID of SIM B (e.g., simID=1) and a cause value indicating the voice call (step 634). The voice call can then begin on SIM B.

The process described in FIG. 6 gives priority to the completion of the RNA update prior to providing the L1 resources of the UE to SIM B for the high priority service. There is no RRC state mismatch between the UE and the 5G NR RAN.

As mentioned above, the RNA update can be considered a special case wherein the UE behavior is not dependent on the current stage of the RRC resume procedure. That is, the RNA update is allowed to proceed regardless of whether the RRC resume request has already been transmitted to the network.

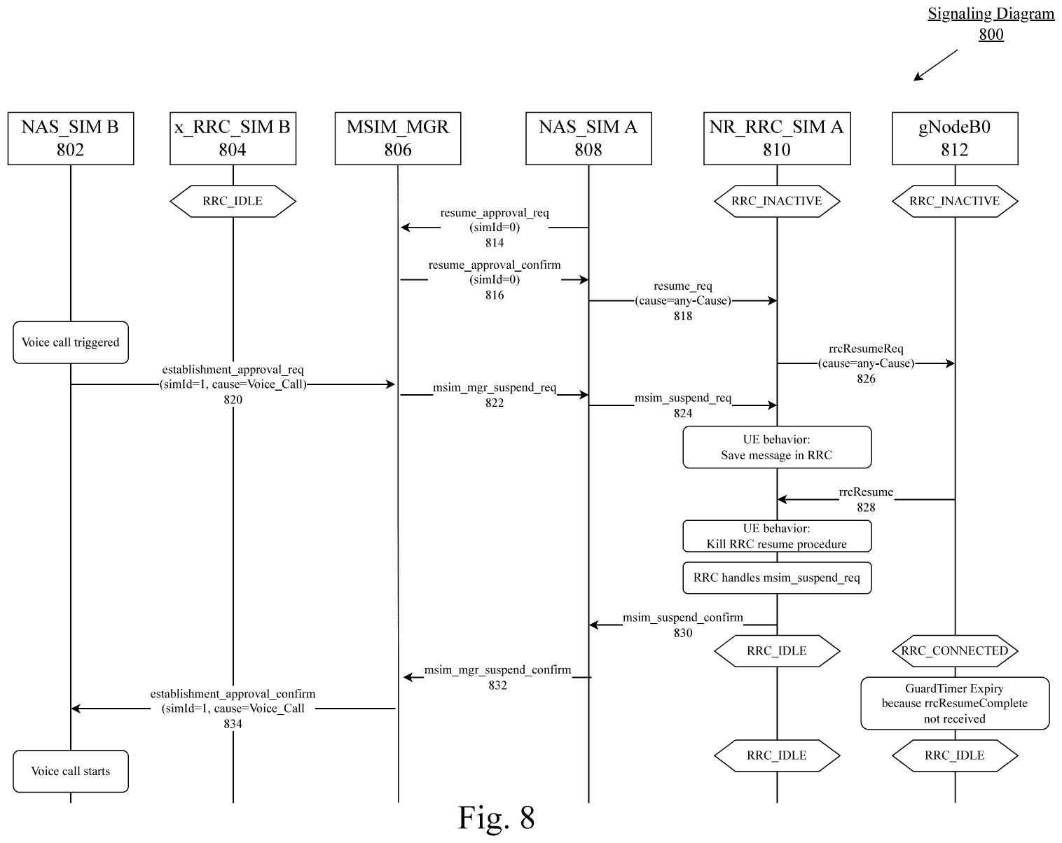

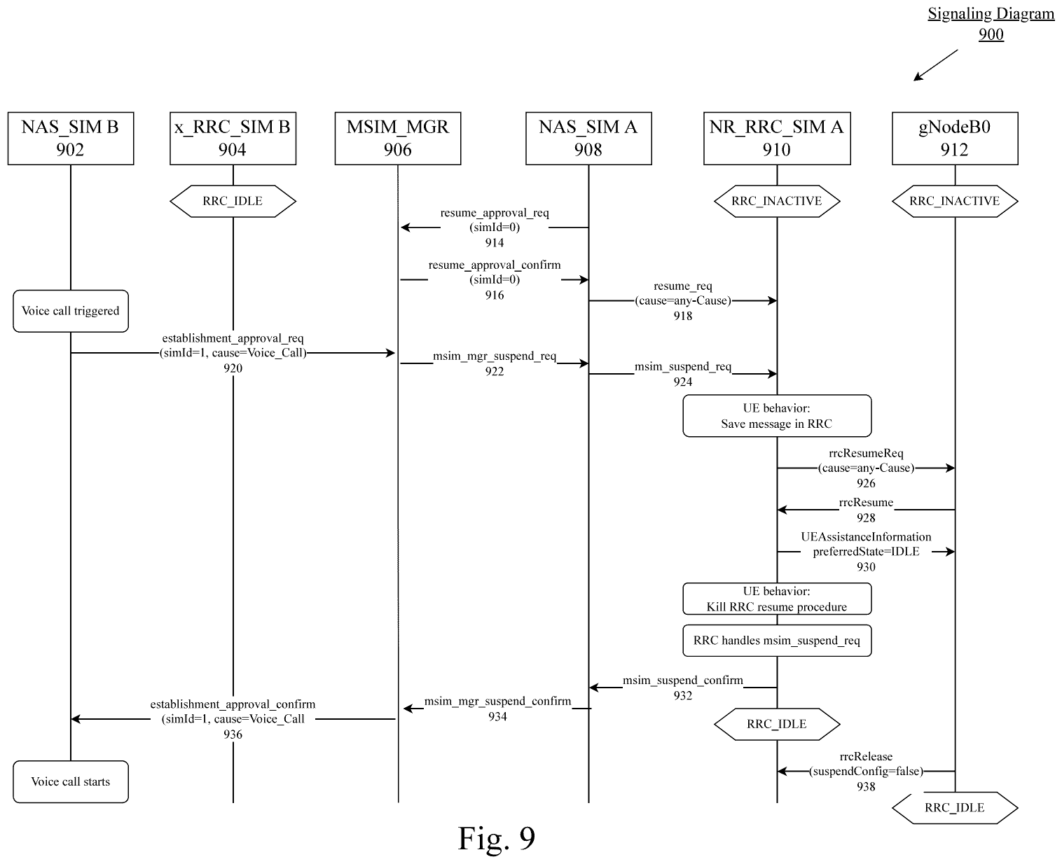

In other scenarios, the RRC resume procedure may be initiated for a reason other than the RNA update. The following operations of FIGS. 7-9 may be performed when the cause for the RRC resume procedure is for a different reason. In FIG. 7 described below, the UE behavior is described for the scenario where the UE receives an RRC reject from the network in response to the RRC resume request. The RRC reject can be received in response to any RRC resume cause, including the RNA update or any other specified cause. In FIGS. 8-9, the UE behavior is described for the scenario where the UE receives an RRC resume from the network in response to the RRC resume request. The RRC resume can be received in response to various RRC resume causes, however, these causes do not include the RNA update cause (wherein only an RRC release or RRC reject can be received).

FIG. 7 shows a signaling diagram 700 for multi-SIM (MSIM) high priority call handling when the high priority call is triggered on a second SIM (SIM B) of a multi-SIM UE while an RRC resume procedure is ongoing for a first SIM (SIM A) of the UE according to a third aspect of these exemplary embodiments. Similar to above, the signaling diagram 700 includes a second non-access stratum (NAS) entity 702 for a second SIM (NAS_SIM B), an RRC entity 704 for the second SIM (x_RRC_SIM B), a multi-SIM manager 706 (MSIM_MGR), a first NAS entity 708 for a first SIM (NAS_SIM A), an NR RRC entity 710 for the second SIM (NR_RRC_SIM A) and a gNB 712. Similar to above, the UE may have a first subscription with a first network (NW A) enabled by the first SIM (SIM A) and a second subscription with a second network (NW B) enabled by the second SIM (SIM B), wherein the first SIM can be associated with a first ID (simID=0) and the second SIM can be associated with a second ID (simID=1). The first SIM (SIM A) is in the RRC INACTIVE state and the RRC INACTIVE context is maintained at the UE (NR_RRC_SIM A 710) and at the network (gNB 712) and the second SIM (SIM B) is in the RRC IDLE state and the RRC IDLE context is maintained at the UE (x_RRC_SIM B 704) and with the corresponding network of SIM B, which can be the same network as SIM A (e.g., the 5G NR RAN) or a different network.

The steps 714-718 of the signaling diagram 700 of FIG. 7 may be performed similarly to the steps 614-618 of the signaling diagram 600 of FIG. 6. The first NAS entity 708 for the first SIM (NAS_SIM A) transmits an RRC resume approval request to the MSIM manager 706 indicating the SIM ID of SIM A (e.g., simID=0) (step 714); the MSIM manager 706 transmits an RRC resume approval confirm to the first NAS entity 708 including the SIM ID of SIM A (step 716); and the NAS entity 708 for SIM A transmits a resume request to the RRC entity 710 for SIM A indicating the any cause value (step 718).

The steps 720-724 of the signaling diagram 700 of FIG. 7 may be performed similarly to the steps 620-624 of the signaling diagram 600 of FIG. 6. The service on the second SIM (SIM B) is triggered (e.g., high priority voice call) and the second NAS entity 702 for SIM B transmits an RRC establishment approval request to the MSIM manager 706 including the SIM ID of SIM B (simId=1) and a cause value indicating the voice call (step 720); the MSIM manager 706 determines that the voice call on SIM B has a higher priority than the RRC resume on SIM A and transmits a RRC suspend request to the first NAS entity 708 for SIM A (step 722); and the first NAS entity 708 transmits a multi-SIM suspend request to the first RRC entity 710 for SIM A (step 724).

As mentioned above, the NR RRC entity 710 for SIM A has not yet received a response from the network (gNB 712) to a RRC resume request. In this example, in 726, the NR RRC entity 710 transmits the RRC resume request to the gNB 712 indicating any cause value prior to receiving the multi-SIM suspend request in 724.

Similar to the signaling diagram 600 of FIG. 6, when the multi-SIM suspend request is received by the NR RRC entity 710, the NR RRC entity 710 temporarily saves the message and delays the execution of the multi-SIM suspend request. For example, the NR RRC entity 710 can save the message in RRC. The execution of the multi-SIM suspend request of step 724 is delayed until the NR RRC entity 710 receives a response from the network.

In this example, in 728, the gNB 712 responds with an RRC reject. The NR RRC entity 710 processes the response and, based on the RRC reject response from the gNB 712, the NR RRC entity 710 re-enters the RRC INACTIVE state. The network (gNB 712) also enters the RRC INACTIVE state. Thus, the INACTIVE context is maintained and it is ensured that the UE and the network are in sync with respect to the RRC context.

Similar to the signaling diagram 600 of FIG. 6, the NR RRC entity 710 retrieves the saved multi-SIM suspend request message and executes the message. Steps 730-734 of the signaling diagram 700 of FIG. 7 may be performed similarly to the steps 626-630 of the signaling diagram 600 of FIG. 6. The NR RRC entity 710 for SIM A transmits a multi-SIM suspend confirm to the first NAS entity 708 (step 730); the first NAS entity 708 transmits a suspend confirm to the MSIM manager 706 (step 732); and the MSIM manager 706 transmits an establishment approval confirmation to the second NAS entity 702 for SIM B indicating the SIM ID of SIM B (e.g., simID=1) and a cause value indicating the voice call (step 734). The voice call can then begin on SIM B.

In the process described in FIG. 7, the UE has already transmitted the RRC resume request to the network. Since the UE typically receives a response from the network within 100-200 ms, the NR RRC entity 710 shall save the suspension because, when the network sends the RRC reject, the UE can preserve the INACTIVE context on SIM A prior to confirming the multi-SIM suspension.

As mentioned above, for cause values other than the RNA update, the UE may receive an RRC resume from the network to move the UE into the RRC CONNECTED state. In FIGS. 8-9, the UE behavior is described for these scenarios. In FIG. 8, the RRC resume request is transmitted to the network prior to receiving the multi-SIM suspend request. In FIG. 9, the RRC resume request has not yet been transmitted to the network prior to receiving the multi-SIM suspend request.

FIG. 8 shows a signaling diagram 800 for multi-SIM (MSIM) high priority call handling when the high priority call is triggered on a second SIM (SIM B) of a multi-SIM UE while an RRC resume procedure is ongoing for a first SIM (SIM A) of the UE according to a fourth aspect of these exemplary embodiments. Similar to above, the signaling diagram 800 includes a second non-access stratum (NAS) entity 802 for a second SIM (NAS_SIM B), an RRC entity 804 for the second SIM (x_RRC_SIM B), a multi-SIM manager 806 (MSIM_MGR), a first NAS entity 808 for a first SIM (NAS_SIM A), an NR RRC entity 810 for the second SIM (NR_RRC_SIM A) and a gNB 812. Similar to above, the UE may have a first subscription with a first network (NW A) enabled by the first SIM (SIM A) and a second subscription with a second network (NW B) enabled by the second SIM (SIM B), wherein the first SIM can be associated with a first ID (simID=0) and the second SIM can be associated with a second ID (simID=1). The first SIM (SIM A) is in the RRC INACTIVE state and the RRC INACTIVE context is maintained at the UE (NR_RRC_SIM A 810) and at the network (gNB 812) and the second SIM (SIM B) is in the RRC IDLE state and the RRC IDLE context is maintained at the UE (x_RRC_SIM B 804) and with the corresponding network of SIM B, which can be the same network as SIM A (e.g., the 5G NR RAN) or a different network.

The steps 814-818 of the signaling diagram 800 of FIG. 8 may be performed similarly to the steps 614-618 of the signaling diagram 700 of FIG. 7. The first NAS entity 808 for the first SIM (NAS_SIM A) transmits an RRC resume approval request to the MSIM manager 806 indicating the SIM ID of SIM A (e.g., simID=0) (step 814); the MSIM manager 806 transmits an RRC resume approval confirm to the first NAS entity 808 including the SIM ID of SIM A (step 816); and the NAS entity 808 for SIM A transmits a resume request to the RRC entity 810 for SIM A indicating the any cause value (step 818). It is noted that, although the step 818 indicates “any-Cause,” the UE will not receive an RRC resume in response to the RNA update request.

The steps 820-824 of the signaling diagram 800 of FIG. 8 may be performed similarly to the steps 720-724 of the signaling diagram 700 of FIG. 7. The service on the second SIM (SIM B) is triggered (e.g., high priority voice call) and the second NAS entity 802 for SIM B transmits an RRC establishment approval request to the MSIM manager 806 including the SIM ID of SIM B (simId=1) and a cause value indicating the voice call (step 820); the MSIM manager 806 determines that the voice call on SIM B has a higher priority than the RRC resume on SIM A and transmits a RRC suspend request to the first NAS entity 808 for SIM A (step 822); and the first NAS entity 808 transmits a multi-SIM suspend request to the first RRC entity 810 for SIM A (step 824).

As mentioned above, the NR RRC entity 810 for SIM A has not yet received a response from the network (gNB 812) to a RRC resume request. In this example, in 826, the NR RRC entity 810 transmits the RRC resume request to the gNB 812 indicating any cause value prior to receiving the multi-SIM suspend request in 824.

Similar to the signaling diagram 700 of FIG. 7, when the multi-SIM suspend request is received by the NR RRC entity 810, the NR RRC entity 810 temporarily saves the message and delays the execution of the multi-SIM suspend request. For example, the NR RRC entity 810 can save the message in RRC. The execution of the multi-SIM suspend request of step 824 is delayed until the NR RRC entity 810 receives a response from the network.

In this example, in 828, the gNB 812 responds with an RRC resume. Thus, the gNB 812 assumes an RRC CONNECTED context with the NR RRC entity 810 of SIM A. However, with the high priority service pending on SIM B, the NR RRC entity 810 will not enter the RRC CONNECTED state.

To allow the high priority service to proceed on SIM B, the NR RRC entity 810 prematurely ends the RRC resume procedure on SIM A and does not transmit an RRC resume complete message to the gNB 812. The UE discards the AS context and enters the RRC IDLE state. Although the gNB 812 temporarily enters the RRC CONNECTED state with the UE, when the RRC resume complete is not received from the UE before the expiry of the T319 timer, the gNB 812 enters the RRC IDLE state with the UE. Thus, although the gNB 812 is unaware of the reason for which the UE did not transmit the RRC resume complete, the NR RRC entity 810 and the gNB 812 both enter the RRC IDLE state and no context mismatch exists between the UE and the gNB 812.

Similar to the signaling diagram 700 of FIG. 7, the NR RRC entity 810 retrieves the saved multi-SIM suspend request message and executes the message. Steps 830-834 of the signaling diagram 800 of FIG. 8 may be performed similarly to the steps 726-730 of the signaling diagram 700 of FIG. 7. The NR RRC entity 810 for SIM A transmits a multi-SIM suspend confirm to the first NAS entity 808 (step 830); the first NAS entity 808 transmits a suspend confirm to the MSIM manager 806 (step 832); and the MSIM manager 806 transmits an establishment approval confirmation to the second NAS entity 802 for SIM B indicating the SIM ID of SIM B (e.g., simID=1) and a cause value indicating the voice call (step 834). The voice call can then begin on SIM B.

In the process described in FIG. 8, the UE has already transmitted the RRC resume request to the network when the multi-SIM suspend request is received from the MSIM manager 806. Since the UE typically receives a response from the network within 100-200 ms, the NR RRC entity 810 shall save the suspension because, when the network sends the RRC resume, the UE knows that ending the RRC resume procedure prematurely will eventually result in the RRC IDLE context being entered into by the 5G NR RAN prior to confirming the multi-SIM suspension.

FIG. 9 shows a signaling diagram 900 for multi-SIM (MSIM) high priority call handling when the high priority call is triggered on a second SIM (SIM B) of a multi-SIM UE while an RRC resume procedure is ongoing for a first SIM (SIM A) of the UE according to a fifth aspect of these exemplary embodiments. Similar to above, the signaling diagram 900 includes a second non-access stratum (NAS) entity 902 for a second SIM (NAS_SIM B), an RRC entity 904 for the second SIM (x_RRC_SIM B), a multi-SIM manager 906 (MSIM_MGR), a first NAS entity 908 for a first SIM (NAS_SIM A), an NR RRC entity 910 for the second SIM (NR_RRC_SIM A) and a gNB 912. Similar to above, the UE may have a first subscription with a first network (NW A) enabled by the first SIM (SIM A) and a second subscription with a second network (NW B) enabled by the second SIM (SIM B), wherein the first SIM can be associated with a first ID (simID=0) and the second SIM can be associated with a second ID (simID=1). The first SIM (SIM A) is in the RRC INACTIVE state and the RRC INACTIVE context is maintained at the UE (NR_RRC_SIM A 910) and at the network (gNB 912) and the second SIM (SIM B) is in the RRC IDLE state and the RRC IDLE context is maintained at the UE (x_RRC_SIM B 904) and with the corresponding network of SIM B, which can be the same network as SIM A (e.g., the 5G NR RAN) or a different network.

The steps 914-918 of the signaling diagram 900 of FIG. 9 may be performed similarly to the steps 614-618 of the signaling diagram 800 of FIG. 8. The first NAS entity 908 for the first SIM (NAS_SIM A) transmits an RRC resume approval request to the MSIM manager 906 indicating the SIM ID of SIM A (e.g., simID=0) (step 914); the MSIM manager 906 transmits an RRC resume approval confirm to the first NAS entity 908 including the SIM ID of SIM A (step 916); and the NAS entity 908 for SIM A transmits a resume request to the RRC entity 910 for SIM A indicating the any cause value (step 918). It is noted that, although the step 918 indicates “any-Cause,” the UE will not receive an RRC resume in response to the RNA update request.

The steps 920-924 of the signaling diagram 900 of FIG. 9 may be performed similarly to the steps 820-824 of the signaling diagram 800 of FIG. 8. The service on the second SIM (SIM B) is triggered (e.g., high priority voice call) and the second NAS entity 902 for SIM B transmits an RRC establishment approval request to the MSIM manager 906 including the SIM ID of SIM B (simId=1) and a cause value indicating the voice call (step 920); the MSIM manager 906 determines that the voice call on SIM B has a higher priority than the RRC resume on SIM A and transmits a RRC suspend request to the first NAS entity 908 for SIM A (step 922); and the first NAS entity 908 transmits a multi-SIM suspend request to the first RRC entity 910 for SIM A (step 924).

As mentioned above, the NR RRC entity 910 for SIM A has not yet received a response from the network (gNB 912) to a RRC resume request. In this example, the NR RRC entity 910 has not yet transmitted the RRC resume request (step 926 below).

Similar to the signaling diagram 800 of FIG. 8, when the multi-SIM suspend request is received by the NR RRC entity 910, the NR RRC entity 910 temporarily saves the message and delays the execution of the multi-SIM suspend request. For example, the NR RRC entity 910 can save the message in RRC. The execution of the multi-SIM suspend request of step 924 is delayed until the NR RRC entity 910 receives a response from the network.

In 926, the NR RRC entity 910 transmits the RRC resume request to the gNB 912 indicating any cause value. In this example, in 928, the gNB 912 responds with an RRC resume. Thus, the gNB 912 assumes an RRC CONNECTED context with the NR RRC entity 910 of SIM A. However, with the high priority service pending on SIM B, the NR RRC entity 910 will not enter the RRC CONNECTED state.

To ensure that the gNB 912 enter the RRC IDLE state, in 930, the NR RRC entity 910 transmits UE assistance information to the gNB 912 indicating a preferred RRC state, e.g., the RRC IDLE state.

To allow the high priority service to proceed on SIM B, the NR RRC entity 910 prematurely ends the RRC resume procedure on SIM A. The UE discards the AS context and enters the RRC IDLE state. Although the gNB 912 temporarily enters the RRC CONNECTED state with the UE, based on the UE assistance information received from the UE, the gNB 912 determines to release the RRC CONNECTED state.

In 938, the gNB 912 transmits an RRC release without a suspend configuration to the NR RRC entity 910 and enters the RRC IDLE state with the UE. Thus, the NR RRC entity 910 and the gNB 912 both enter the RRC IDLE state and no context mismatch exists between the UE and the gNB 912.

Similar to the signaling diagram 800 of FIG. 8, the NR RRC entity 910 retrieves the saved multi-SIM suspend request message and executes the message. Steps 932-936 of the signaling diagram 900 of FIG. 9 may be performed similarly to the steps 826-830 of the signaling diagram 800 of FIG. 8. The NR RRC entity 910 for SIM A transmits a multi-SIM suspend confirm to the first NAS entity 908 (step 932); the first NAS entity 908 transmits a suspend confirm to the MSIM manager 906 (step 934); and the MSIM manager 906 transmits an establishment approval confirmation to the second NAS entity 902 for SIM B indicating the SIM ID of SIM B (e.g., simID=1) and a cause value indicating the voice call (step 936). The voice call can then begin on SIM B.

In the process described in FIG. 9, the UE has not yet transmitted the RRC resume request to the network when the multi-SIM suspend request is received from the MSIM manager 906. However, to ensure that no context mismatch will exist if the RRC resume is received, the UE continues with the RRC resume procedure so that the UE can indicate to the network the preferred RRC state of RRC IDLE. The signaling required for this procedure comprises only two OTA messages (e.g., the UE assistance information transmission of 930 and the RRC release of 932), which is minor relative to the OTA messages that would be required if the RRC context mismatch exists.

In an additional embodiment, the UE can maintain an internal timer to control the wait time between the transmission of the RRC resume request and the reception of any DL messages to ensure the UE does not wait too long, in the rare event that the T319 timer is longer than, e.g., 100 ms.

To summarize, according to the exemplary embodiments of FIGS. 5-9 described above, the UE is provided with every possible chance to maintain the INACTIVE context on SIM A when the RRC resume procedure is interrupted on SIM B, while minimizing signaling between the UE and the gNB. This may lead to power saving in the UE and avoids the need for a TAU procedure in most scenarios due to multi-SIM conflicts. The exemplary embodiments will lead to optimized network resource usage, e.g., improving the end-to-end system performance specified by 3GPP.

The exemplary embodiments further avoid a context mismatch between the UE and gNB. The UE is provided with the opportunity to transmit rrcResumeRequest/1 and receive rrcRelease (suspendConfig=True)/rrcReject without interruption to ensure that both the UE and the gNB are in RRC INACTIVE state. Upon receiving the rrcResume in response to the rrcResumeRequest, the UE may either send UeAssistanceInformation (state=Idle) and then immediately locally release the rrcConnection or discard the rrcResume and release the INACTIVE context. Since the gNodeB will not receive the rrcResumeComplete, it will release the Inactive context after the expiry of the procedure guard timer, ensuring that both entities are in RRC_IDLE.

The exemplary embodiments can provide an enhanced user experience due to low latency in Call Setup in many use cases due to the saving of the INACTIVE state context. Further, the UE avoids handicapping Tx and Rx capabilities of SIMs due to additional signaling between the UE and the network.

The exemplary embodiments are further applicable to any RAT where the 3GPP INACTIVE state is applicable, including 4G and future RATs, e.g., 5G-Advanced, 6G, etc.

### EXAMPLES

In a first example, a method performed by a user equipment (UE), comprising entering a radio resource control (RRC) INACTIVE state on a first network using a first subscriber identification module (SIM) and an RRC INACTIVE or RRC IDLE state on a second network using a second SIM, initiating an RRC resume procedure on the first SIM, the RRC resume procedure including a transmission of a resume request including a cause indication from a non-access stratum (NAS) entity of the first SIM to an RRC entity of the first SIM, during the RRC resume procedure on the first SIM, receiving a trigger for a service on the second SIM having a higher priority than the RRC resume procedure on the first SIM, based on the trigger for the service on the second SIM, initiating a multi-SIM suspend procedure on the first SIM, the multi-SIM suspend procedure including a transmission of a multi-SIM suspend request from the NAS entity of the first SIM to the RRC entity of the first SIM and at the RRC entity of the first SIM, delaying an execution of the multi-SIM suspend request until a response to an RRC resume request is received from the first network.

In a second example, the method of the first example, wherein the cause indication comprises a radio access network (RAN)-based notification area (RNA) update.

In a third example, the method of the second example, wherein the execution of the multi-SIM suspend request is delayed regardless of whether the RRC resume request of the RRC resume procedure has already been transmitted to the first RAN when the multi-SIM suspend request is received at the RRC entity of the first SIM.

In a fourth example, the method of the third example, wherein the response to the RRC resume request comprises an RRC reject or an RRC release including a suspend configuration, the method further comprising re-entering the RRC INACTIVE state on the first SIM based on either a previous suspend configuration or the suspend configuration in the RRC release and executing the multi-SIM suspend request on the first SIM and starting the service on the second SIM.

In a fifth example, the method of the third example, wherein the response to the RRC resume request comprises an RRC release not including a suspend configuration, the method further comprising entering the RRC IDLE state on the first SIM based on the RRC release and executing the multi-SIM suspend request on the first SIM and starting the service on the second SIM.

In a sixth example, the method of the first example, wherein the cause indication comprises any cause and the RRC resume request is transmitted to the first network prior to the RRC entity for the first SIM receiving the multi-SIM suspend request.

In a seventh example, the method of the sixth example, wherein the response to the RRC resume request comprises an RRC reject, the method further comprising re-entering the RRC INACTIVE state on the first SIM based on a previous suspend configuration and executing the multi-SIM suspend request on the first SIM and starting the service on the second SIM.

In an eighth example, the method of the sixth example, wherein the response to the RRC resume request comprises an RRC resume, the method further comprising ending the RRC resume procedure and entering the RRC IDLE state on the first SIM and executing the multi-SIM suspend request on the first SIM and starting the service on the second SIM.

In a ninth example, the method of the first example, wherein the cause indication comprises any cause and the multi-SIM suspend request is received prior to transmitting the RRC resume request to the first network, the method further comprising transmitting the RRC resume request to the first network and receiving an RRC resume from the first network.

In a tenth example, the method of the ninth example, further comprising transmitting UE assistance information to the first network indicating a preferred RRC state, the preferred RRC state comprising the RRC IDLE state, ending the RRC resume procedure and entering the RRC IDLE state on the first SIM and executing the multi-SIM suspend request on the first SIM and starting the service on the second SIM.

In an eleventh example, the method of the tenth example, further comprising receiving a RRC release without a suspend configuration from the first network in response to the UE assistance information.

In a twelfth example, the method of the first example, wherein the multi-SIM suspend request is saved in RRC until execution.

In a thirteenth example, the method of the first example, wherein the service on the second SIM is a high priority voice call.

In a fourteenth example, a processor configured to perform any of the methods of the first through thirteenth examples.

In a fifteenth example, a user equipment (UE) comprising a transceiver configured to communicate with a network and a processor communicatively coupled to the transceiver and configured to perform any of the methods of the first through thirteenth examples.

Those skilled in the art will understand that the above-described exemplary embodiments may be implemented in any suitable software or hardware configuration or combination thereof. An exemplary hardware platform for implementing the exemplary embodiments may include, for example, an Intel x86 based platform with compatible operating system, a Windows OS, a Mac platform and MAC OS, a mobile device having an operating system such as iOS, Android, etc. In a further example, the exemplary embodiments of the above described method may be embodied as a program containing lines of code stored on a non-transitory computer readable storage medium that, when compiled, may be executed on a processor or microprocessor.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

1. An apparatus of a user equipment (UE), the apparatus comprising processing circuitry configured to:
enter a radio resource control (RRC) INACTIVE state on a first network using a first subscriber identification module (SIM) and an RRC INACTIVE or RRC IDLE state on a second network using a second SIM;
initiate an RRC resume procedure on the first SIM, the RRC resume procedure including a transmission of a resume request including a cause indication from a non-access stratum (NAS) entity of the first SIM to an RRC entity of the first SIM;
during the RRC resume procedure on the first SIM, decode, based on signals signaling received from a base station, a trigger for a service on the second SIM having a higher priority than the RRC resume procedure on the first SIM;
based on the trigger for the service on the second SIM, initiate a multi-SIM suspend procedure on the first SIM, the multi-SIM suspend procedure including a transmission of a multi-SIM suspend request from the NAS entity of the first SIM to the RRC entity of the first SIM; and
at the RRC entity of the first SIM, delay an execution of the multi-SIM suspend request until a response to an RRC resume request is received from the first network.

2. The apparatus of claim 1, wherein the cause indication comprises a radio access network (RAN)-based notification area (RNA) update.

3. The apparatus of claim 2, wherein the execution of the multi-SIM suspend request is delayed regardless of whether the RRC resume request of the RRC resume procedure has already been transmitted to the first network when the multi-SIM suspend request is received at the RRC entity of the first SIM.

4. The apparatus of claim 3, wherein the response to the RRC resume request comprises an RRC reject or an RRC release including a suspend configuration, wherein the processing circuitry is further configured to:
re-enter the RRC INACTIVE state on the first SIM based on either a previous suspend configuration or the suspend configuration in the RRC release; and
execute the multi-SIM suspend request on the first SIM and start the service on the second SIM.

5. The apparatus of claim 3, wherein the response to the RRC resume request comprises an RRC release not including a suspend configuration, wherein the processing circuitry is further configured to:
enter the RRC IDLE state on the first SIM based on the RRC release; and
execute the multi-SIM suspend request on the first SIM and start the service on the second SIM.

6. The apparatus of claim 1, wherein the cause indication comprises any cause and the RRC resume request is transmitted to the first network prior to the RRC entity for the first SIM receiving the multi-SIM suspend request.

7. The apparatus of claim 6, wherein the response to the RRC resume request comprises an RRC reject, wherein the processing circuitry is further configured to:
re-enter the RRC INACTIVE state on the first SIM based on a previous suspend configuration; and
execute the multi-SIM suspend request on the first SIM and start the service on the second SIM.

8. The apparatus of claim 6, wherein the response to the RRC resume request comprises an RRC resume, wherein the processing circuitry is further configured to:
end the RRC resume procedure and entering the RRC IDLE state on the first SIM; and
execute the multi-SIM suspend request on the first SIM and start the service on the second SIM.

9. The apparatus of claim 1, wherein the cause indication comprises any cause and the multi-SIM suspend request is received prior to transmitting the RRC resume request to the first network, wherein the processing circuitry is further configured to:
configure transceiver circuitry to transmit generate, for transmission to the first network, a message comprising the RRC resume request to the first network; and
decode, based on signals signaling received from the first network, an RRC resume.

10. The apparatus of claim 9, wherein the processing circuitry is further configured to:
configure transceiver circuitry to transmit generate, for transmission to the first network, UE assistance information to the first network indicating a preferred RRC state, the preferred RRC state comprising the RRC IDLE state;
end the RRC resume procedure and entering the RRC IDLE state on the first SIM; and
execute the multi-SIM suspend request on the first SIM and start the service on the second SIM.

11. The apparatus of claim 10, wherein the processing circuitry is further configured to:
Decode process, based on signals signaling received from the first network, a RRC release without a suspend configuration in response to the UE assistance information.

12. The apparatus of claim 1, wherein the multi-SIM suspend request is saved in RRC until execution.

13. The apparatus of claim 1, wherein the service on the second SIM is a high priority voice call.

14. A user equipment (UE), comprising:
a transceiver configured to communicate with a first network and a second network; and
a processor communicatively coupled to the transceiver and configured to:
enter a radio resource control (RRC) INACTIVE state on the first network using a first subscriber identification module (SIM) and an RRC INACTIVE or RRC IDLE state on the second network using a second SIM;
initiate an RRC resume procedure on the first SIM, the RRC resume procedure including a transmission of a resume request including a cause indication from a non-access stratum (NAS) entity of the first SIM to an RRC entity of the first SIM;
during the RRC resume procedure on the first SIM, decode, based on signals signaling received from a base station, a trigger for a service on the second SIM having a higher priority than the RRC resume procedure on the first SIM;
based on the trigger for the service on the second SIM, initiate a multi-SIM suspend procedure on the first SIM, the multi-SIM suspend procedure including a transmission of a multi-SIM suspend request from the NAS entity of the first SIM to the RRC entity of the first SIM; and
at the RRC entity of the first SIM, delay an execution of the multi-SIM suspend request until a response to an RRC resume request is received from the first network.

15. The UE of claim 14, wherein the cause indication comprises a radio access network (RAN)-based notification area (RNA) update.

16. The UE of claim 15, wherein the execution of the multi-SIM suspend request is delayed regardless of whether the RRC resume request of the RRC resume procedure has already been transmitted to the first network when the multi-SIM suspend request is received at the RRC entity of the first SIM.

17. The UE of claim 14, wherein the cause indication comprises any cause and the RRC resume request is transmitted to the first network prior to the RRC entity for the first SIM receiving the multi-SIM suspend request.

18. The UE of claim 14, wherein the cause indication comprises any cause and the multi-SIM suspend request is received prior to transmitting the RRC resume request to the first network, wherein the processor is further configured to:
configure the transceiver to transmit the RRC resume request to the first network; and
decode, based on signals signaling received from the first network, an RRC resume.

19. The UE of claim 14, wherein the multi-SIM suspend request is saved in RRC until execution.

20. The UE of claim 14, wherein the service on the second SIM is a high priority voice call.
